(19) United States
(12) Patent Application Publication
(10) Pub. No.: US 2007/0007082 A1
(43) Pub. Date: Jan. 11, 2007

(54) Helical screw lift system for an elevator

(76) Inventor: Kaj Guy Nielsen, Kelowna (CA)

Correspondence Address: ANTONY C. EDWARDS, SUITE 200 - 270 HIGHWAY 33 WEST, KELOWNA, BC, V1X 1X7, CA

(21) Appl. No.: 11/442,320

(22) Filed: May 30, 2006

Related U.S. Application Data
(63) Continuation-in-part of application No. 10/887,875, filed on Jul. 12, 2004, now abandoned.
(60) Provisional application No. 60/492,995, filed on Aug. 7, 2003.

(51) Int. Cl. B66B 9/02

(52) U.S. Cl. 187/267

(57) ABSTRACT

A helical screw lift system for an elevator includes a rigid vertical frame having at least one rigid vertical rail; and a single elongate helical screw having an inclined helical flight. The screw is rotatably vertically mounted to the frame at opposite ends of the screw. A motor mounted to the frame rotates the screw. A carriage is mounted to the vertical rail for vertical translation. An elevator platform is mounted to the carriage. Four wheels are rigidly mounted cantilevered from the carriage. The wheels engage and bear down on the helical flight of the screw for rolling translation therealong when the screw is rotated about its longitudinal axis so as to raise or lower the elevator platform.

### CROSS-REFERENCE TO RELATED APPLICATION

This is a Continuation-in-Part Patent Application of U.S. patent application Ser. No. 10/887,875 filed Jul. 12, 2004 which claims priority from U.S. Provisional Patent Application Ser. No. 60/492,995 filed Aug. 7, 2003 entitled Helical Screw Lift System for an Elevator.

### FIELD OF THE INVENTION

This invention relates to a lift system which employs a single helical screw for reciprocal vertical movement of a platform or elevator car between landings.

### BACKGROUND OF THE INVENTION

The rapid vertical transportation of persons and materials between multiple floors or landings has long been accomplished by conventional elevator systems which utilize several well known drive systems such as hydraulic systems and traction or winch systems Most of these systems are intended for accommodating multiple passengers between multiple floors such as in office buildings and apartments.

As the proportion of elderly persons continues to increase as a percentage of our society, and as medical technology enables ambulatory dysfunctional persons to live full and healthy lives, there has been an increased interest in the design of a safe, quiet and relatively inexpensive elevator system to assist the elderly or the handicapped with transporting themselves between several levels as would be normally found within a residential home, small institution such as a care facility or the exterior access of public and private buildings.

In many circumstances an access ramp is utilized for access adjacent the exterior entry of a building. Such device requires a substantial horizontal distance to maintain a slope suitable for walking or for wheel chair operation. Where inclement weather is experienced the ramp may need to be covered. Such construction is generally obstructive and unsightly.

Most of the current lift systems are unsuited for conversion to use in a domestic application or for use between two or three floors due to size, cost or the complexity of ancillary operating components as well as the expense of regular servicing to maintain them in a safe working condition. Further, current systems are not generally adaptable to being custom designed for either interior or exterior use in small residential or institutional application.

In the prior art the applicant is aware of U.S. Pat. No. 5,080,200, which issued Jan. 14, 1992 to Gibson for a Ball Screw Elevator Drive System. In this application the elevator is suspended from a pulley journalled at an end of a telescoping lift tube. A screw drive shaft within the fixed tube supports a ball assembly fixedly mounted to the telescoping tube. Rotation of the screw shaft by a motor results in raising or lowering of the ball assembly, the lift tube and with it the elevator.

The applicant is also aware of U.S. Pat. No. 4,742,891, which issued May 10, 1988 to Kunii et al for an Elevator System, where it is disclosed to mount an elevator car on a vertical screw shaft by a rotary element which is mounted on the car and threadably engaged with the screw shaft. Rotation of the screw shaft drives the car in the vertical direction.

The applicant is further aware of U.S. Pat. No. 696,994, which issued Apr. 8, 1902 to Modry for an Electric Elevator. This reference shows an elevator carriage of generally square cross section having a helical screw positioned at each of the corners. Pairs of rollers having their rotational axes generally at right angles to each other are positioned at the comers within the well so as to engage adjacent threads of the screw. Rotation of the screws by an electric motor mounted beneath the carriage result in raising or lowering of the carriage.

It is an object of the present invention to provide an inexpensive, relatively maintenance free elevator primarily for short vertical travel as would normally be found in a residence or small care facility. Such an elevator may be installed within the interior of a building so as to provide alternative access between floors or landings, or at the exterior of a building, to provide easy handicapped access into buildings where the main public access is elevated above ground level.

It is an object to provide an elevator where the car of the elevator is supported on one or more, and in a preferred embodiment, four freely rotating wheels, which rest on the helically inclined upper surface or flight of a single helical screw. Rotation of the helical screw results in rotation of the freely rotatable wheels along the inclined flight thereby vertically translating the elevator car.

### SUMMARY OF THE INVENTION

The present invention is an elevator lift system, which employs a single helical screw for reciprocal vertical deployment or translation of a platform or car.

The elevator car is supported on a generally vertically disposed carriage frame which is positioned between and mounted to two vertical spaced apart guide rails. The guide rails are themselves mounted to a vertically separated series of brackets, which are firmly attached to suitable framework in the case of a freestanding lift unit, or to suitable building framework in the case of a conventional elevator.

Pairs of guide wheels are mounted to the side members of the carriage frame, near the upper and lower corners thereof so as to sandwich the vertical guide rails between them.

The carriage frame has one or more and preferably four supporting wheels mounted to a cross member of the carriage so as to engage the helically inclined flight of the single helical screw. In one embodiment, the screw may be positioned medially of the rails and coaxially with the vertical axis of the carriage frame. An elevator car or platform is mounted cantilevered to the supporting carriage frame.

The helical screw is jounialled at its lower end on bearings mounted on a pedestal or base member. A reversible electric motor is mounted to the opposite upper end of the helical screw to selectively rotate the screw to either raise or lower the car supporting carriage frame. In one embodiment, a self locking speed reducer may be employed, mounted between the motor and screw, to inhibit inadvertent reverse rotation of the screw when the electric motor disengages from positive rotation of the screw so as to prevent the inadvertent downward creep of the elevator car.

In summary, the helical screw lift system for an elevator according to the present invention includes:
a) a rigid vertical frame, the frame including at least one rigid vertical rail;
b) a single elongate helical screw having an inclined helical flight, the screw rotatably vertically mounted to the frame at opposite ends of the screw;
c) a selectively actuable drive means mounted to the frame and cooperating with the screw for selectively actuable rotation of the screw so as to selectively reversibly rotate the helical flight of the screw;
d) a carriage mounted to the vertical rail for vertical translation, for example on vertical translation means such as wheels or rollers, vertically along the rail;
e) an elevator platform for carrying a load such as cargo and people, rigidly mounted to, so as to be cantilevered from, the carriage;
f) a rolling means, such as at least one and preferably four wheels or rollers, rigidly mounted cantilevered from the carriage so as to engage and bear down on the helical flight for rolling translation therealong when the screw is rotated about its longitudinal axis,
g) at least one screw stabilizer mounted to the carriage to maintain alignment of the rolling means with the screw.

The rotational bending moments acting on the rail due to the platform being mounted cantilevered from the carriage are entirely borne by the carriage engaging the rail. A corresponding downward bending moment about a horizontal moment axis through the carriage and the rail is resisted both by an upper translation means component of the vertical translation means mounted on an upper end of the carriage in vertically translatable engagement against a first surface of the rail which is opposite from the platform, and by a lower translation means component of the vertical translation means mounted on a lower end of the carriage in vertically translatable engagement against a second surface of the rail which is opposite from the first surface. The upper and lower ends of the carriage are, respectively, above and below the horizontal moment axis.

In one embodiment not intended to be limiting, the rail is a pair of laterally spaced apart, parallel vertical rails and the vertical translation means are rollers or wheels rotatably mounted on vertically opposite ends of the carriage, and the screw is parallel to and generally equi-distantly spaced between the pair of rails. In a preferred embodiment the rollers or wheels engaging the helical flight are cantilevered from the carriage so as to oppositely disposed relative to the platform., and may be slightly toed inwardly at forward ends of the rollers or wheels relative to an inclined path of the rollers or wheels upwardly along the flight of the screw.

### BRIEF DESCRIPTION OF THE DRAWINGS

FIG. 1, is a left side perspective view of a self-supporting elevator according to the present invention.

FIG. 2 is a right side perspective view of the elevator of FIG. 1.

FIG. 3 is a rear elevation view of the self-supporting elevator illustrated in FIG. 1.

FIG. 4 is a sectional view taken on line 4-4 of FIG. 1.

FIG. 5 is a partially cut-away perspective view of a portion of FIG. 4.

FIG. 5a is, in front elevation view, the elevator of FIG. 5 modified to include screw stabilizers.

FIG. 6 is a front elevation enlarged view of a portion of FIG. 5.

FIG. 7 is a schematic electrical diagram according to one embodiment of a two level elevator of the present invention.

FIG. 8 is a schematic electrical diagram according to the embodiment of FIG. 8 illustrating the control arrangement within the elevator car and on the two levels.

FIG. 9a is, in front elevation partially exploded view, one screw stabilizer of the elevator embodiment illustrated in FIG. 5a.

FIG. 9b is, in exploded plan view, the screw stabilizer of FIG. 9a.

FIG. 9c is, in end elevation view, the screw stabilizer of FIG. 9a.

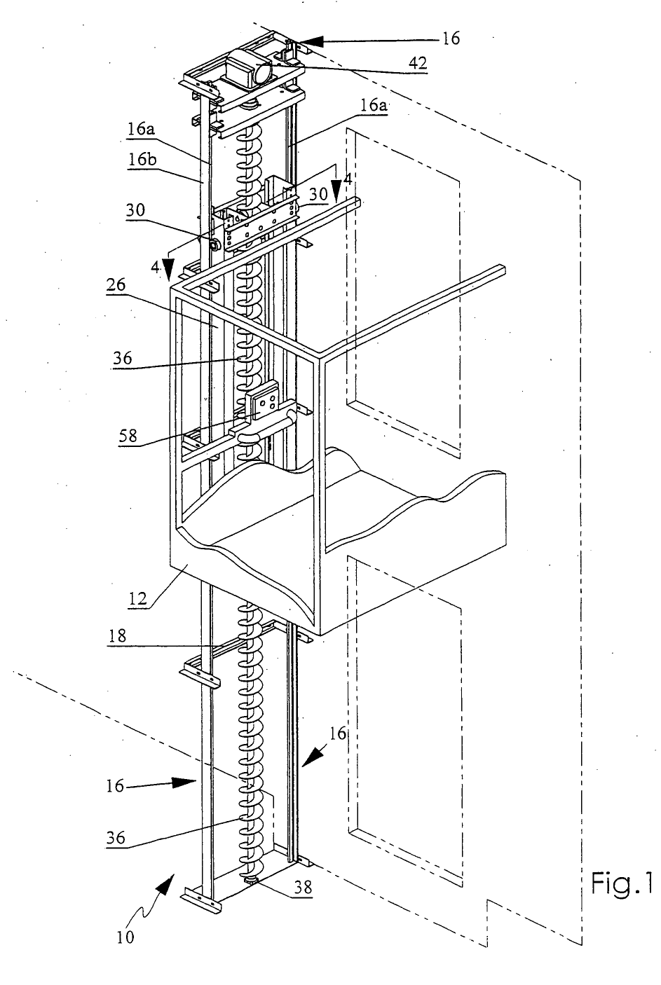

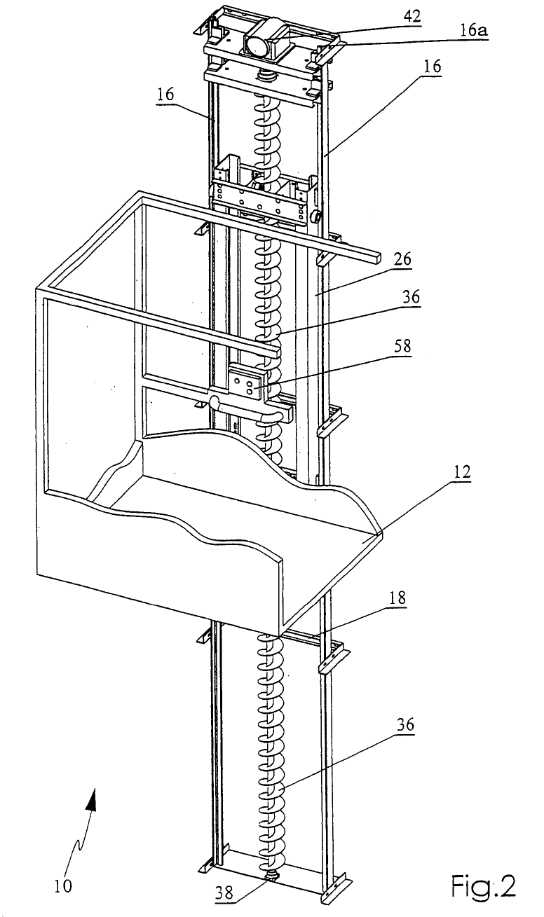

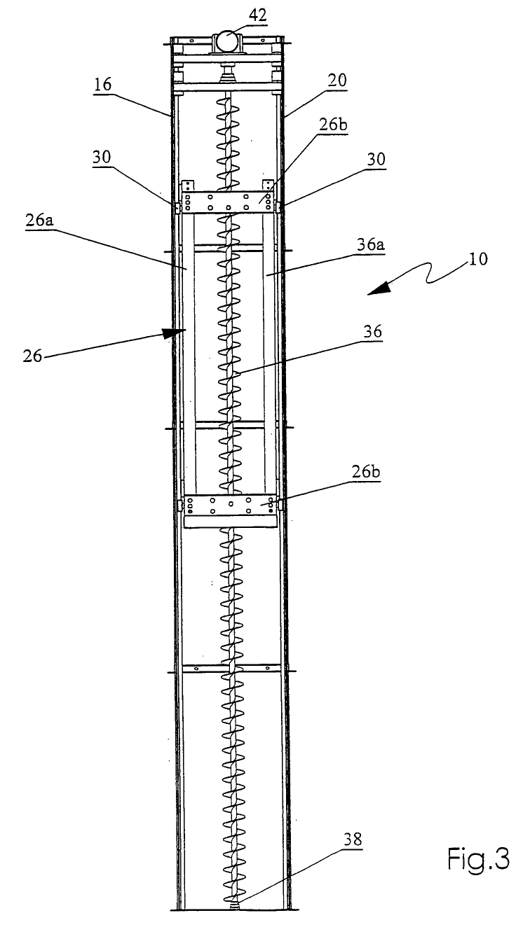

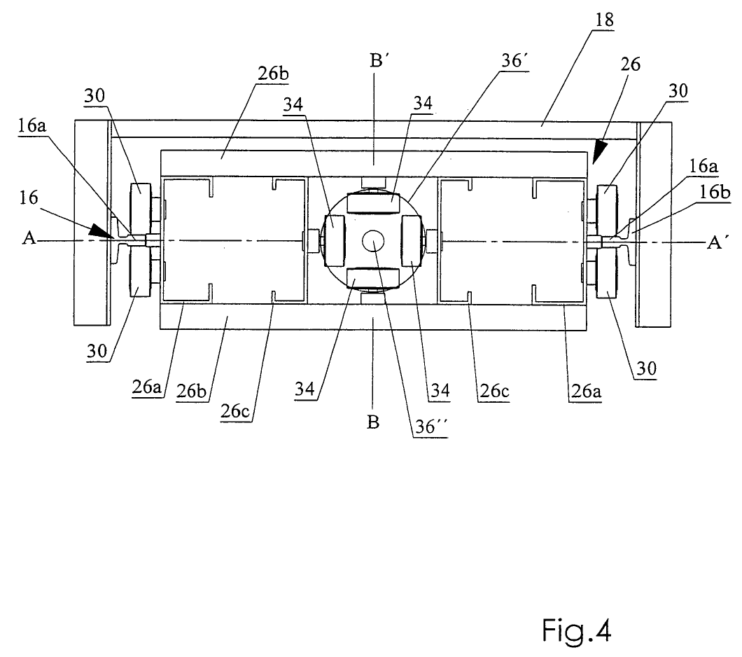

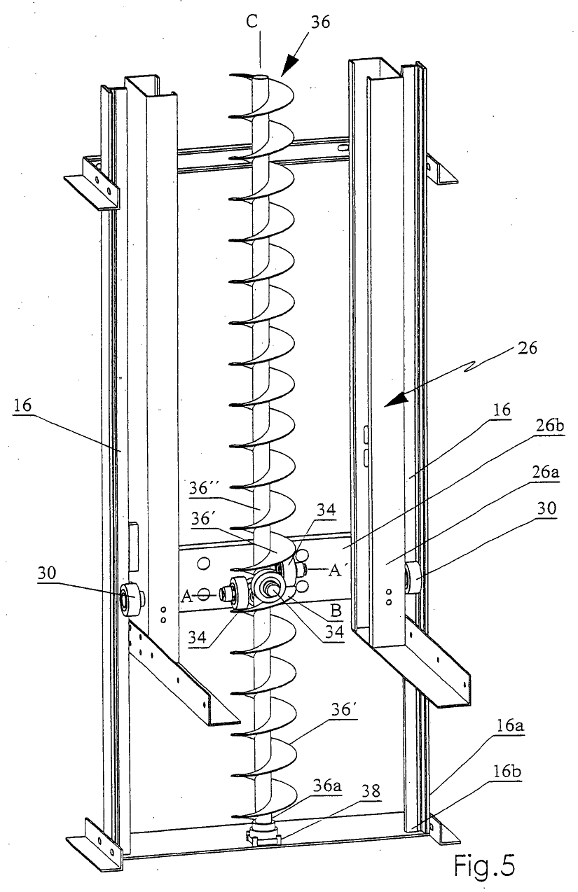

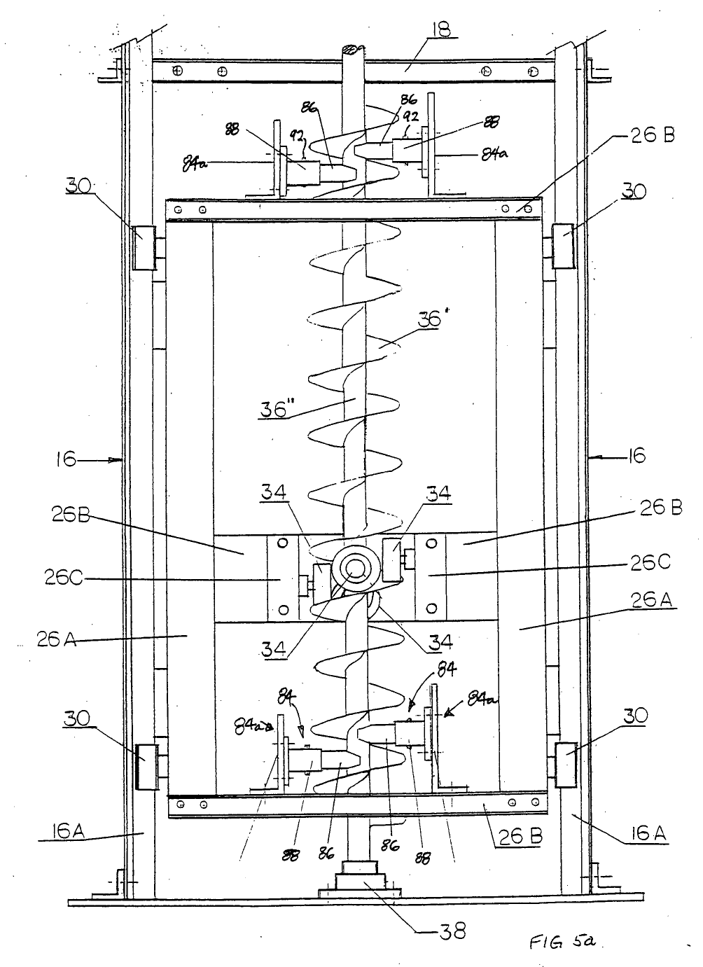

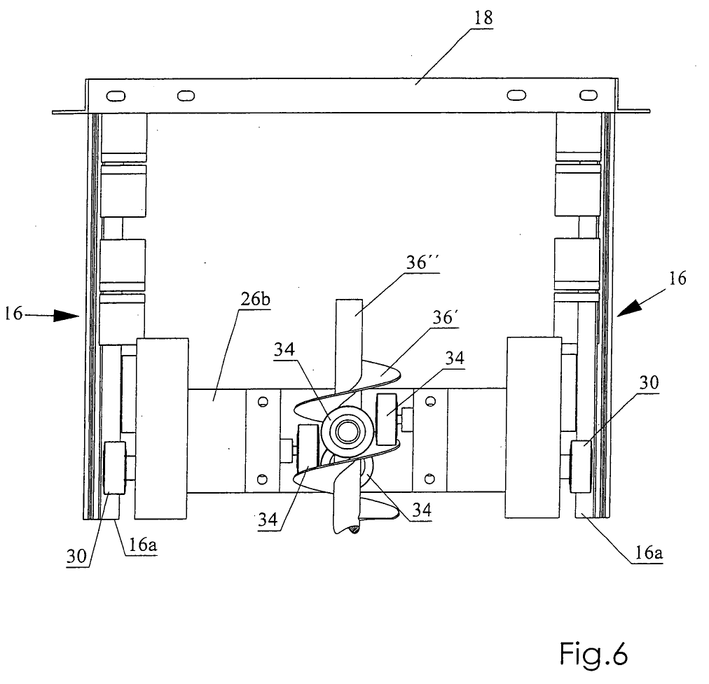

### DETAILED DESCRIPTION OF EMBODIMENTS OF THE INVENTION

With reference to the drawing figures, wherein similar characters of reference denote corresponding parts in each view, elevator 10 has a platform or car 12, which is slidably mounted for reciprocal vertical movement on guide rails 16. Rails 16 have a bearing member 16a and side faces 16b. Rails 16 are securely fastened to supporting brackets 18 so as to be secured parallel and spaced apart. Brackets 18 may be mounted by welding or bolting or the like to either external supporting members (not shown) where the elevator is self-supporting, or to building frame members where the elevator is attached to a structure.

Elevator car 12 has a vertically disposed supporting carriage or carriage frame 26 mounted between for translation parallel to guide rails 16. Frame 26 includes side brackets 26a and cross brackets 26b. Guide wheels 30 are mounted in transversely spaced apart pairs at the upper and lower corners of each side bracket 26a. Rail 16 is sandwiched between the upper and lower pairs of wheels 30 with bearing members 16a of the rails in contact with and between the wheels. Four idler rollers 34 are mounted to frame 26. A first pair are mounted in opposed facing relation on cross brackets 26b at a point intermediate between side brackets 26a, and a second pair are mounted in opposed facing relation on cross members 26c, orthogonally, when viewed in plan view, relative to the first pair of idler rollers. The axes of rotation B and B′ of the first pair of idler rollers 34 extend at right angles to the axes of rotation A and A′ of the second pair of idler rollers 34, which pass through the center of rails 16.

Vertical reciprocating movement of both elevator car 12 and supporting frame 26 is accomplished by a single elongate helical screw 36, which is rotatably vertically mounted intermediate rails 16. Screw 36 has a helically inclined flight 36′ rigidly mounted on a single vertical shaft 36″. Flight 36′ has in one embodiment a 4 inch pitch, that is 4 inches of vertical travel per screw revolution. A 48:1 ratio on flight 36′, with a 4 horsepower DC motor 42 operating at 3600 R.P.M. equates to 75 revolutions per minute which in turn equates to an elevator travel speed of 25 feet per minute with a torque of 70.02 in/lbs. The horizontal rotational axes A and B of rollers 34 intersect the vertical axis of rotation C of screw 36. Helical screw 36 is positioned so that rollers 34 rests solidly upon the screw flight 36′. Screw shaft 36″ is journalled at its lower end 36a on bearings such as conical, so-called Dodge bearings mounted in a pedestal base 38. A reversible electrical motor 42 is mounted at the opposite upper end of screw shaft 36″. Motor 42 is operated to rotate screw 36 to either raise or lower both frame 26 and elevator car 12.

In a preferred embodiment, upper and lower pairs of screw stabilizers 84 are mounted to support brackets 84a, themselves mounted on cross-brackets 26b so as to extend upwardly therefrom. Screw stabilizers 84 in each of the upper and lower pairs are mounted so as to be opposed facing to resiliently snug collars 86a of collar slides 86 in direction D against screw shaft 36″ at the upper and lower ends of carriage frame 26. Collar slides 6 are telescopically housed within sleeves 88 for snug sliding translation in direction D under the resiliently biased urging of springs 90. Pins 92 or bolts or the like joumalled through apertures 88b in sleeves 88 slide in slots 86c to limit the travel of the slides 86 so as to bear the opposite ends of the springs against base members 88a of sleeves 88. Consequently, slides 86 may be translated in directions opposite to direction D against the return biasing force of springs 90. Thus each opposed facing pair of screw stabilizers 84 serve to resiliently center any deflection or bowing of shaft 36″ and to dampen vibration or vibrating motion of screw shaft 36″ during rotation of screw 36. This serves inter alia to quieten operation of the elevator, reduce fatigue of shaft 36″ and wear of rollers 34 on flight 36′, and to keep rollers 34 on their optimum path up along flight 36′ while under load. In a preferred embodiment slides 86 are made of nylon such as Nyloil™ and springs 90 are of 0.080 inch diameter wire and have an outside diameter of five eighths of an inch and a length of two inches. Springs 90 are mounted at first ends thereof in sockets 86b in slides 86.

A self locking speed reducer (not shown) may be employed, mounted between the motor and screw, to prevent the angular component of the vertical load transferring to screw 36 from the stationary elevator car 12 through wheels 34 so as to cause reverse rotation of screw 36 and the inadvertent downward creep of elevator car 12.

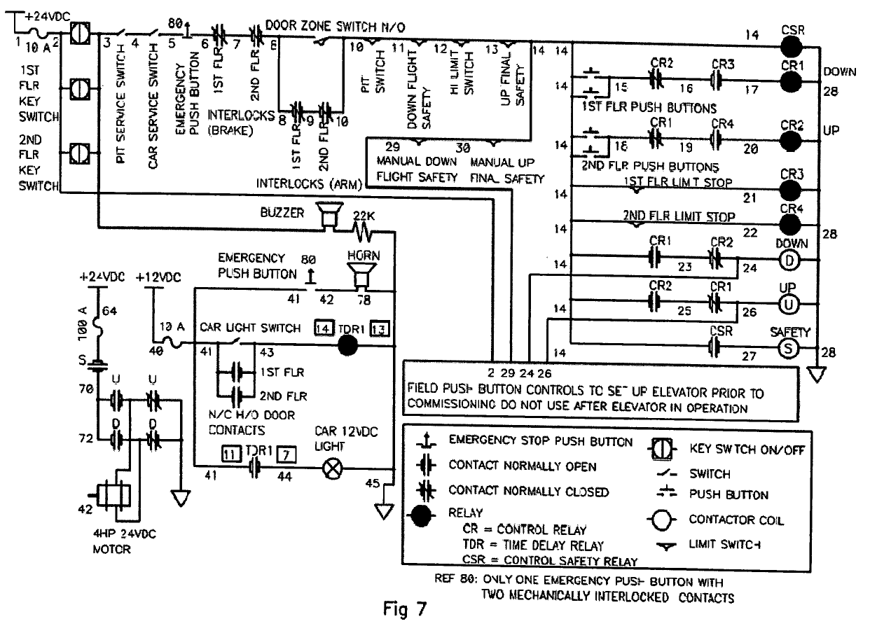

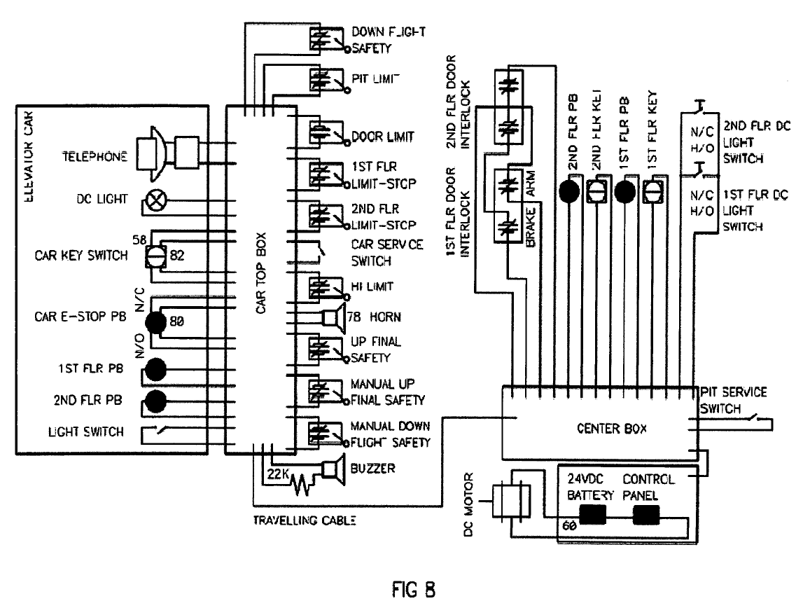

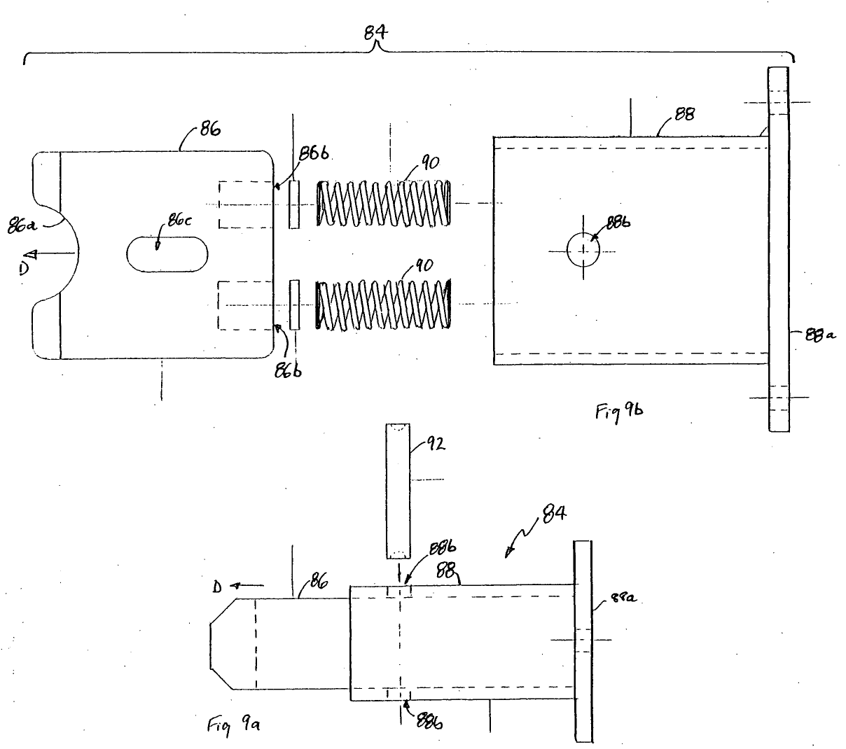

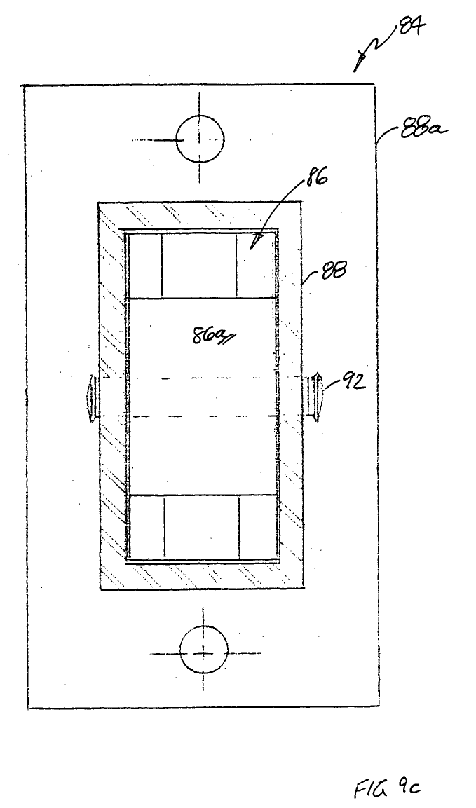

FIG. 7 schematically illustrates a direct current electrical diagram for operation of the elevator. FIG. 8 illustrates the main operating circuit. FIG. 8 illustrates the circuits from the push-button console 58 in the elevator car. Power is obtained from battery 60, which may be continuously trickle-charged by a trickle charger (not shown). Current flows through circuit breaker 64 to contacts 70, which controls motor 42 for upward movement of the elevator car. Current also travels to contacts 72, which controls downward movement of the elevator car. A horn 78 is activated when the emergency stop button 80 is activated on console 58. Button 80 also immediately cuts operating power to the circuit. Console 58 must be activated through key switch 82 in order to power the circuitry.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A helical screw lift system for an elevator comprising:
a) a rigid vertical frame, said frame including at least one rigid vertical rail;
b) a single elongate helical screw having an inclined helical flight, said screw rotatably vertically mounted to said frame at opposite ends of said screw;
c) a selectively actuable drive means mounted to said frame and cooperating with said screw for selectively actuable rotation of said screw about a longitudinal axis of said screw so as to selectively reversibly rotate said helical flight of said screw;
d) a carriage mounted to said vertical rail for vertical translation, on vertical translation means, vertically along said rail;
e) an elevator platform, rigidly mounted to, said carriage;
f) a rolling means mounted cantilevered from said carriage so as to engage and bear down on said helical flight for rolling translation therealong when said screw is rotated about said longitudinal axis;
g) at least one screw stabilizer mounted to said carriage to maintain alignment of said rolling means with said screw.

2. The system of claim I wherein said screw is only a single screw and said rolling means includes a plurality of rollers or wheels radially spaced about said longitudinal axis of said screw and all bearing down on said flight.

3. The system of claim 2 wherein bending moments acting on said rail due to said platform being mounted to said carriage are borne by said carriage engaging said rail, wherein a corresponding downward bending moment about a horizontal moment axis through said carriage and said rail is resisted both by an upper translation means component of said vertical translation means mounted on an upper end of said carriage in vertically translatable engagement against a first surface of said rail which is opposite from a lower translation means component, and by means of said lower translation means component of said vertical translation means mounted on a lower end of said carriage in vertically translatable engagement against a second surface of the rail which is opposite from said first surface of said rail.

4. The system of claim 3 wherein the upper and lower ends of said carriage are, respectively, above and below said horizontal moment axis.

5. The system of claim I wherein said at least one rail is a laterally spaced apart, parallel pair of vertical rails and wherein said vertical translation means include rollers or wheels rotatably mounted on vertically opposite ends of said carriage, and wherein said screw is parallel to said pair of vertical rails.

6. The system of claim 5 wherein said screw is equidistant between said pair of vertical rails.

7. The system of claim 1 wherein said platform is cantilevered from said carriage.

8. The system of claim 7 wherein said vertical translation means include rollers or wheels which are cantilevered from said carriage.

9. The system of claim 8 wherein said rollers or wheels are cantilevered from said carriage oppositely relative to said platform.

10. The system of claim 2 wherein said plurality of rollers or wheels are equally radially spaced about said longitudinal axis.

11. The system of claim 10 wherein said plurality is four rollers or wheels.

12. The system of claim I wherein said screw includes a screw shaft and said at least one screw stabilizer comprises at least one bearing member providing a substantially annular bearing surface within which said screw shaft is snugly joumalled.

13. The system of claim 12 wherein said at least one bearing member includes at least one pair of opposed facing collars, each collar of said pair of opposed facing collars having an arcuate bearing surface so as to form said substantially annular bearing surface with said arcuate bearing surfaces arranged in opposed facing array on opposite sides of said screw shaft.

14. The system of claim 13 wherein said at least one pair of opposed facing collars includes upper and lower pairs of opposed facing collars each mounted to, respectively, upper and lower ends of said elevator carriage.

15. The system of claim 14 wherein each said collar is resiliently mounted for resilient deflection of said collars upon a lateral deflection of said screw shaft against the return biasing force of said collars.

16. The system of claim 15 wherein each said collar is mounted snugly in sliding engagement in a corresponding sleeve, and wherein a resilient biasing means is mounted within said sleeve so as to resiliently bias said collar outwardly of said sleeve against said screw shaft.

17. The system of claim 16 wherein said resilient biasing means includes at least one spring.

18. The system of claim 17 wherein each said collar is substantially saddle-shaped so that said screw shaft is cradled resiliently between said opposed facing pair of said collars for rotation of said screw shaft while snugly and resiliently supported on opposite sides of said screw shaft by each said pair of said opposed facing collars.
